(19) United States
(12) Patent Application Publication
(10) Pub. No.: US 2018/0222453 A1
(43) Pub. Date: Aug. 9, 2018

(54) Safety structure for hand brake

(71) Applicants: Jun-Rui YANG, Taichung City (TW); Gui-Ping LIAO, Taichung City (TW); Zhen-Jie LIAO, Taichung City (TW)

(72) Inventors: Jun-Rui YANG, Taichung City (TW); Gui-Ping LIAO, Taichung City (TW); Zhen-Jie LIAO, Taichung City (TW)

(21) Appl. No.: 15/716,539

(22) Filed: Sep. 27, 2017

(30) Foreign Application Priority Data
Feb. 8, 2017 (US) 15427071

(51) Int. Cl. B60T 7/10; B60T 8/32; B60T 8/17; B60T 8/18; B60T 11/04

(52) U.S. Cl. CPC B60T 7/10; B60T 8/3225; B62L 1/06; B60T 8/1881; B60T 11/046; B60T 8/1706

(57) ABSTRACT

A safety structure for a hand brake contains: a casing, a body, a roller rotatably, a first brake line, a second brake line, and a third brake line. The first brake line are connected with a first brake and a second brake of a vehicle, and the second brake line is coupled with a first controller on a left handle of the vehicle, the third brake line is coupled with a second controller on a right handle of the vehicle. The first brake line is bent in half and has two shoulders adjacent to the roller, and an outer diameter of each of the two shoulders is more than the first brake line so that when the first brake line is broken, at least one of the two shoulders stops inside the body or the casing, and at least one of the first and second brakes stops the vehicle.

### FIELD OF THE INVENTION

The present invention relates to a safety structure for a hand brake which is capable of adjusting a distance between the first brake and the second brake of a vehicle.

### BACKGROUND OF THE INVENTION

Referring to FIG. 13, a conventional safety structure for a hand brake contains: a casing 11, a body 12 accommodated in the body 11, a roller rotatably connected with the body 12, a first brake line 14 bent in half, a second brake line 15 and a third brake line 16 which are connected with the body 12.

Two ends of the first brake line 14 are in connection with a first brake 17 and a second brake 18 individually, the second brake line 15 is joined with a first controller (not shown) of a first brake, and the third brake line 16 is coupled with a second controller (not shown) of a second brake. Thereby, when the second brake line 15 or the third brake line 16 is pulled, the first brake line 14 is driven by the body 12 and is adjustably rotated by way of the roller 13 so that the first brake line 14 pulls the first brake 17 and the second brake 18, thus adjusting a distance between the first brake and the second brake.

In case the first brake line 14 is broken, the first brake 17 and the second brake 18 do not stop vehicle.

The present invention has arisen to mitigate and/or obviate the afore-described disadvantages.

### SUMMARY OF THE INVENTION

The primary aspect of the present invention is to provide a safety structure for a hand brake which is capable of adjusting a distance between the first brake and the second brake of a vehicle so as to stop the vehicle safely as at least one brake line is broken.

A safety structure for a hand brake provided by the present invention contains: a casing, a body accommodated in the casing, a roller rotatably connecting with the body, a first brake line rolled on the roller, a second brake line and a third brake line both connecting with the body;

two ends of the first brake line being individually connected with a first brake and a second brake of a vehicle, and the second brake line being coupled with a first controller on a left handle of the vehicle, the third brake line being coupled with a second controller on a right handle of the vehicle.

The first brake line is bent in half and has two shoulders arranged on the two ends of the first brake line respectively adjacent to the roller, and an outer diameter of each of the two shoulders is more than the first brake line so that when the first brake line is broken, at least one of the two shoulders stops inside the body or the casing, and at least one of the first and second brakes stops the vehicle.

### BRIEF DESCRIPTION OF THE DRAWINGS

FIG. 1 is a perspective view showing the assembly of a safety structure for a hand brake according to a first embodiment of the present invention.

FIG. 2 is a perspective view showing the exploded components of the safety structure for the hand brake according to the first embodiment of the present invention.

FIG. 3 is a cross sectional view showing the assembly of the safety structure for the hand brake according to the first embodiment of the present invention.

FIG. 4 is a cross sectional view showing the application of the safety structure for the hand brake according to the first embodiment of the present invention.

FIG. 5 is a cross sectional view showing the operation of the safety structure for the hand brake according to the first embodiment of the present invention.

FIG. 6 is another cross sectional view showing the operation of the safety structure for the hand brake according to the first embodiment of the present invention.

FIG. 7 is also another cross sectional view showing the operation of the safety structure for the hand brake according to the first embodiment of the present invention.

FIG. 8 is still another cross sectional view showing the operation of the safety structure for the hand brake according to the first embodiment of the present invention.

FIG. 9 is a cross sectional view showing the assembly of a safety structure for a hand brake according to a second embodiment of the present invention.

FIG. 10 is a cross sectional view showing the operation of the safety structure for the hand brake according to the second embodiment of the present invention.

FIG. 11 is a perspective view showing the application of the safety structure for the hand brake according to the first embodiment of the present invention.

FIG. 12 is a perspective view showing the application of the safety structure for the hand brake according to the first embodiment of the present invention.

FIG. 13 is a cross sectional view showing the assembly of a conventional safety structure for a hand brake.

### DETAILED DESCRIPTION OF THE PREFERRED EMBODIMENTS

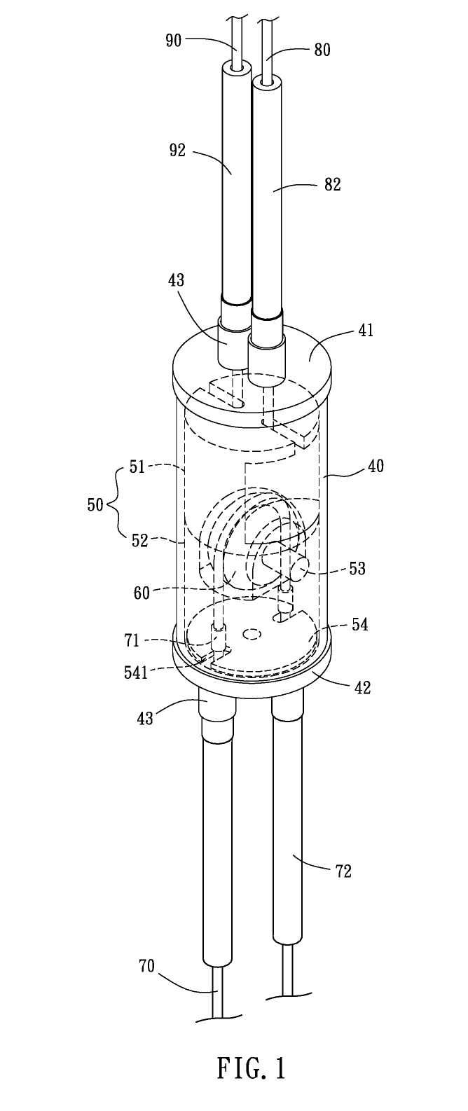

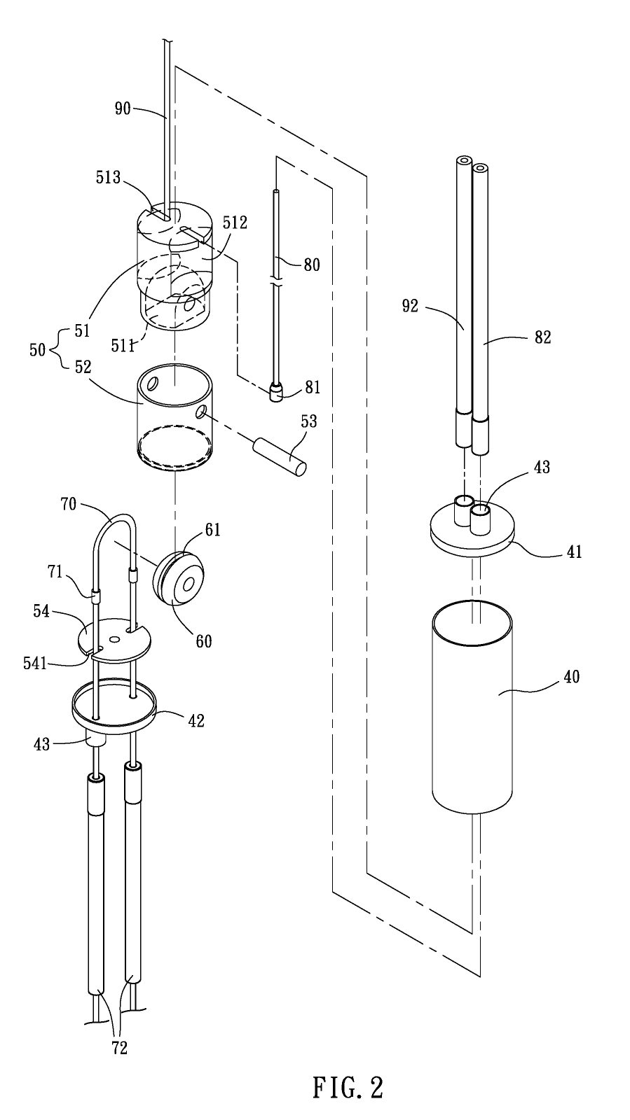

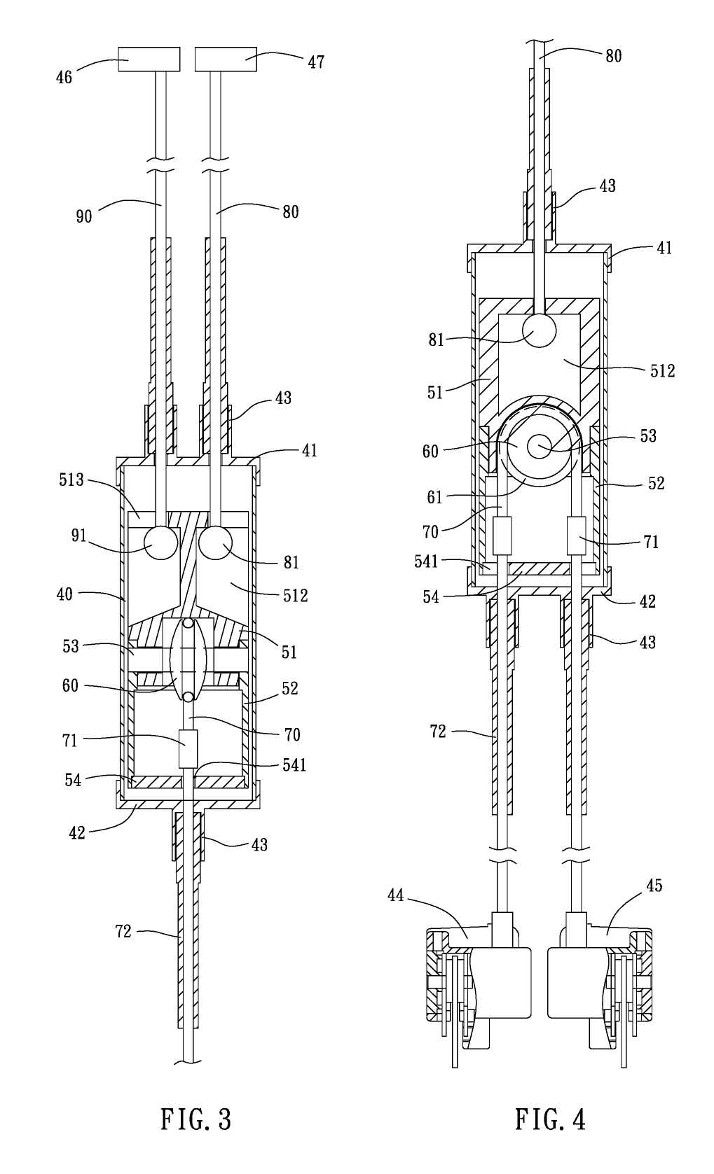

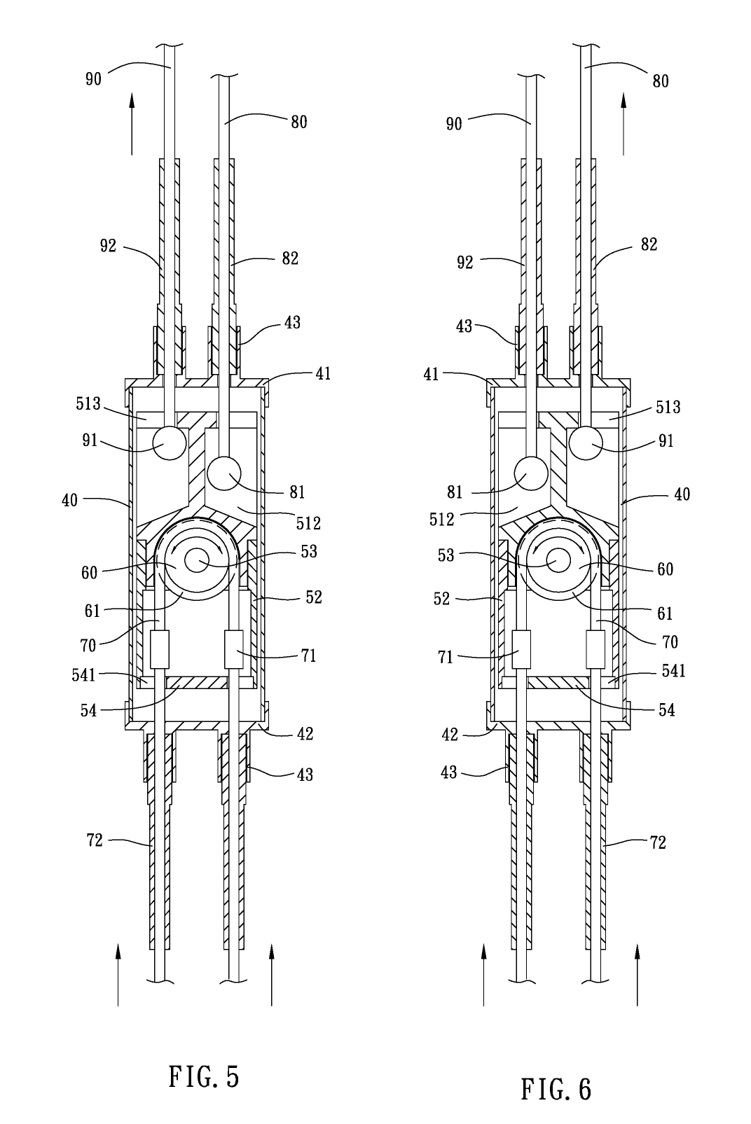

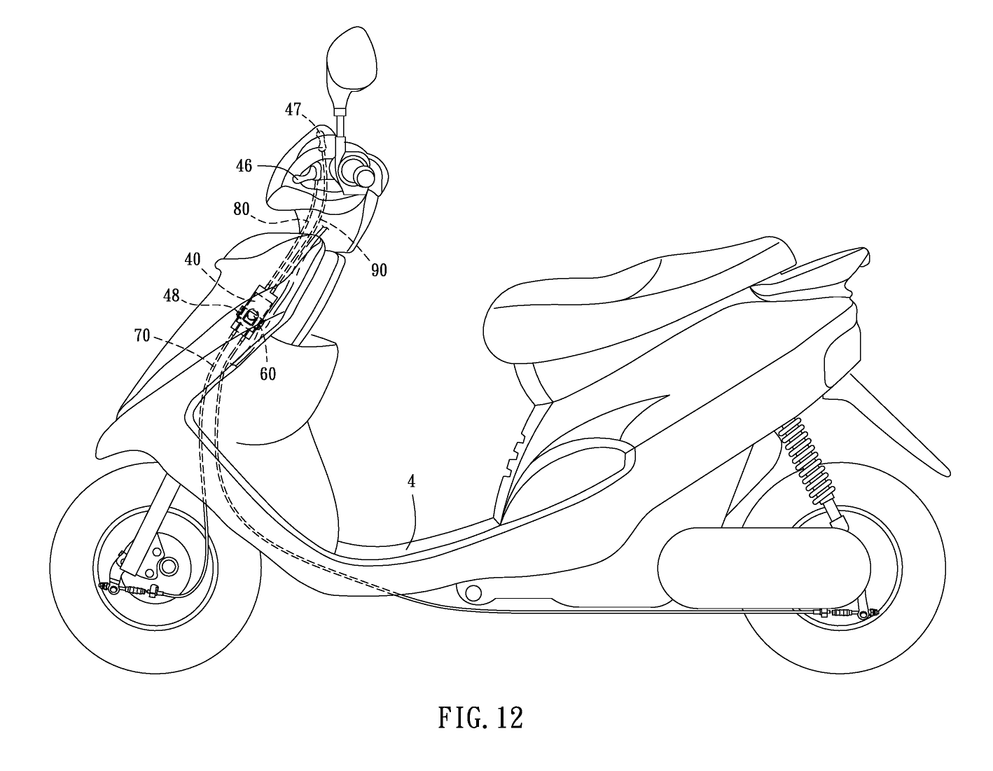

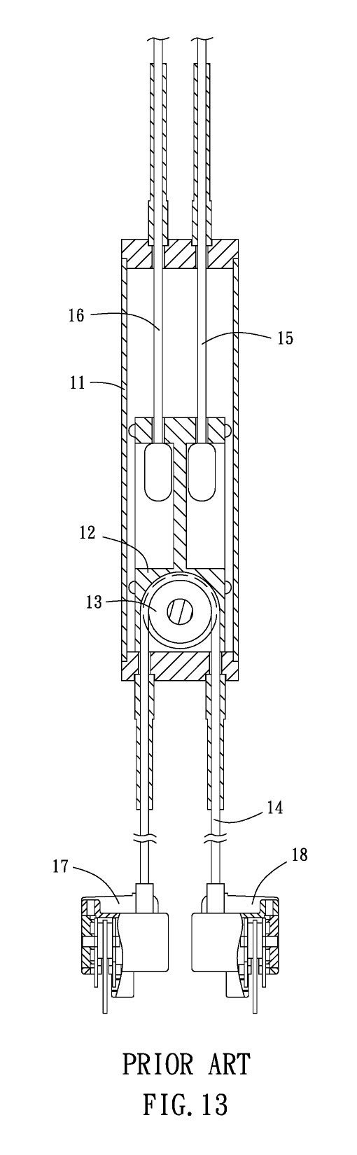

With reference to FIGS. 1 to 12, a safety structure for a hand brake according to a preferred embodiment of the present invention is employed to a brake system of a vehicle 4 (such as a bicycle or a motorcycle), and the safety structure comprises: a casing 40, a body 50, a roller 60, a first brake line 70, a second brake line 80, and a third brake line 90.

The casing 40 is a hollow cylinder, and the casing 40 includes a first cap 41 and a second cap 42 which are arranged on two outer ends of the casing 40 respectively, wherein each of the first cap 41 and the second cap 42 has two positioning portions 43 passing therethrough.

The body 50 is accommodated in the casing 40, and the body 50 includes a central shaft 51 and a fitting sleeve 52 fitted with the central shaft 51, wherein the central shaft 51 has an accommodation chamber 511 defined in a first end thereof and corresponding to the fitting sleeve 52 so as to house the roller 60. The body 50 further includes a fixing post 53 rotatably connecting with the roller 60 and the fitting sleeve 52, and the central shaft 51 has two separation portions 512 respectively formed on two peripheral sides of a second end thereof and communicating with two orifices 513 of the central shaft 51 so as to connect with the second brake line 80 and the third brake line 90. The fitting sleeve 52 is hollow and includes a lid 54 housed in the first end thereof opposite to the central shaft 51, wherein the lid 54 has two opposite cutouts 541 defined on a peripheral side thereof and configured to accommodate the first brake line 70.

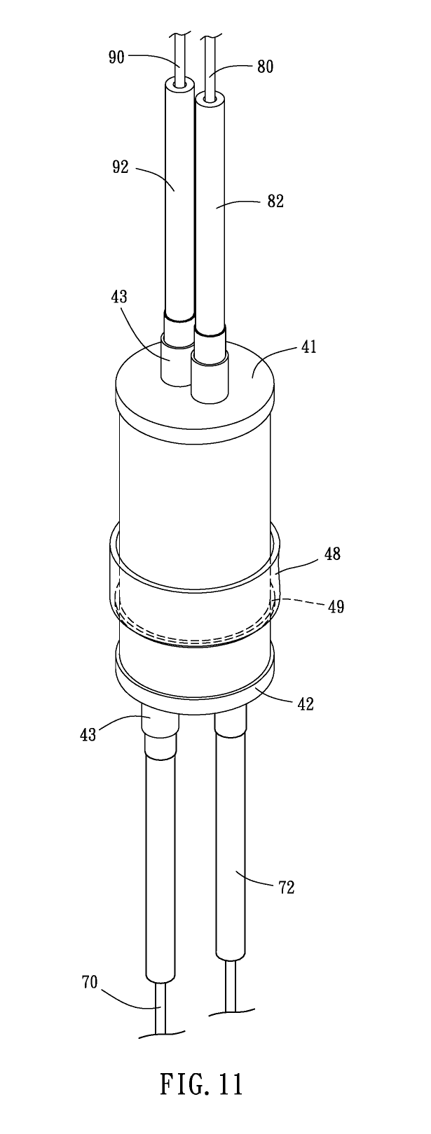

Referring to FIG. 11, the first cap 41 has a first sheath 48 and a second sheath 49 fitted with the first cap 41, wherein an inner diameter of each of the first sheath 48 and the second sheath 49 is more than an inner diameter of the casing 40 and is less than an outer diameter of each of the first cap 41 and the second cap 42, and an outer diameter of each of the first cap 41 and the second cap 42 is more than an outer diameter of the casing 40 so that the first sheath 48 and the second sheath 49 fit with the casing 40 securely.

The roller 60 includes a peripheral groove 61 formed around an rim thereof and includes a through hole 62 configured to accommodate the fixing post 53 so that the roller 60 is housed in the accommodation chamber 511, after the fixing post 53 is housed in the through hole 62.

The first brake line 70 is bent in half and is partially accommodated in the peripheral groove 61 of the roller 60, and two ends of the first brake line 70 are individually connected with a first brake 44 and a second brake 45 of the vehicle 4 via the two opposite cutouts 541 of the lid 54, wherein the first brake line 70 has two shoulders 71 arranged on the two ends of the first brake line 70 respectively adjacent to the roller 60, and each of the two shoulders 71 is made of metal and is a circular column fitted on the first crake line 70, wherein an outer diameter of each shoulder 71 is more than that of the first brake line 70, each of the two opposite cutouts 541, and each of the two positioning portions 43.

The second brake line 80 includes a first head portion 81 formed on a first end thereof more than a second end of the second brake line 80, and the first head portion 81 retains in one of the two orifices 513 of the body 50, and the second end of the second brake line 80 is coupled with a first controller 46 on a left handle of the vehicle 4.

The third brake line 90 includes a second head portion 91 formed on a first end thereof more than a second end of the third brake line 90, the second head portion 91 retains in the other orifice 513 of the body 50, and the second end of the third brake line 90 is coupled with a second controller 47 on a right handle of the vehicle 4.

The first brake line 70 includes two first plastic tubes 72 fitted on the two ends thereof respectively and accommodated in the two positioning portions 43 of the second cap 42, the second brake line 80 includes a second plastic tube 82 fitted on the first end thereof and accommodated in the positioning portion 43 of the first cap 41, and the third brake line 90 includes a third plastic tube 92 fitted on the first end thereof and accommodated in the positioning portion 43 of the first cap 41.

Thereby, the first brake line 70 mates with the roller 60 so as to adjust a distance between the first brake 44 and the second brake 45 as braking the vehicle.

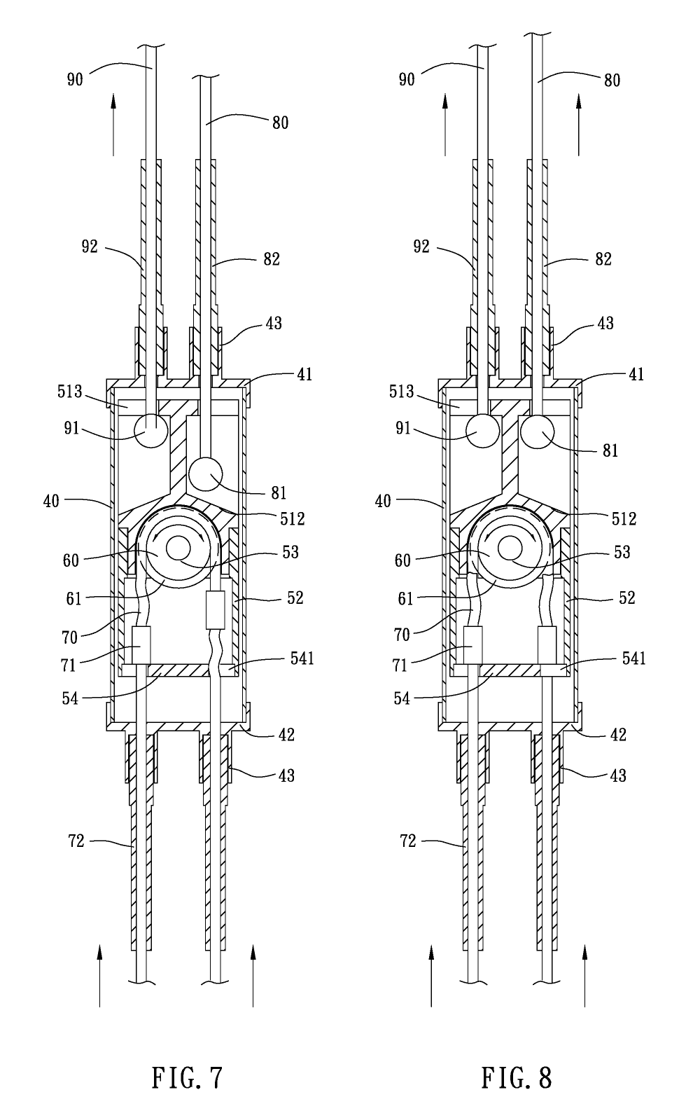

As shown in FIG. 7, when one end of the first brake line 70 is broken, the shoulder 71 on the other end of the two shoulders 71 stops besides the cutout 541 of the lid 54 so as to brake the vehicle.

As illustrated in FIG. 8, as a middle portion of the first brake line 70 is broken, the two shoulders 71 of the first brake line 70 stops insides the two opposite cutouts 541 of the lid 54 so that the first brake 44 and the second brake 45 brake the vehicle safely. In addition, when the left and right handles of the vehicle 4 rotate, the casing 40 revolves in the first sheath 48 and the second sheath 49 so as to reduce friction of the casing 40.

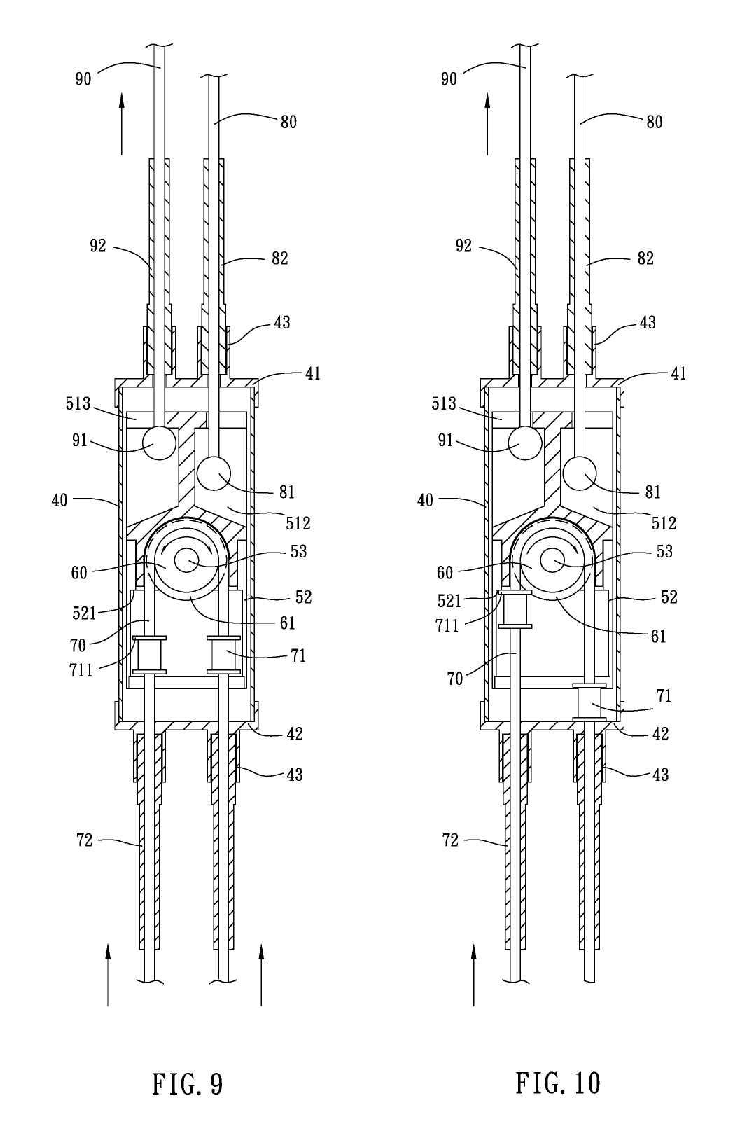

Referring to FIGS. 9 and 10, each shoulder 71 has two flanges 711 formed on two ends thereof respectively, and the fitting sleeve 52 has a stepped portion 521 arranged on a top of an inner wall thereof, hence when the first brake line 70 is broken, the two flanges 711 of each shoulder 71 are stopped by the stepped portion 521 so as to brake the vehicle firmly.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A safety structure for a hand brake comprising:
a casing, a body accommodated in the casing, a roller rotatably connecting with the body, a first brake line rolled on the roller, a second brake line and a third brake line both connecting with the body;
two ends of the first brake line being individually connected with a first brake and a second brake of a vehicle, and the second brake line being coupled with a first controller on a left handle of the vehicle, the third brake line being coupled with a second controller on a right handle of the vehicle;
wherein the first brake line is bent in half and has two shoulders arranged on the two ends of the first brake line respectively adjacent to the roller, and an outer diameter of each of the two shoulders is more than the first brake line so that when the first brake line is broken, at least one of the two shoulders stops inside the body or the casing, and at least one of the first and second brakes stops the vehicle.

2. The safety structure as claimed in claim 1, wherein the first brake line includes two first plastic tubes fitted on the two ends thereof respectively and accommodated in two positioning portions of a second cap, the second brake line includes a second plastic tube fitted on a first end thereof and accommodated in the positioning portion of a first cap, and the third brake line includes a third plastic tube fitted on a first end thereof and accommodated in the positioning portion of the first cap.

3. The safety structure as claimed in claim 1, wherein the body includes a central shaft and a fitting sleeve fitted with the central shaft, the central shaft has an accommodation chamber defined in a first end thereof and corresponding to the fitting sleeve so as to house the roller, the body further includes a fixing post rotatably connecting with the roller and the fitting sleeve, and the central shaft has two separation portions respectively formed on two peripheral sides of a second end thereof and communicating with two orifices of the central shaft so as to connect with the second brake line and the third brake line.

4. The safety structure as claimed in claim 3, wherein the fitting sleeve is hollow and includes a lid housed in the first end thereof opposite to the central shaft, the lid has two opposite cutouts defined on a peripheral side thereof and configured to accommodate the first brake line, and an outer diameter of each shoulder is more than that of the first brake line, each of the two opposite cutouts, and each of the two positioning portions.

5. The safety structure as claimed in claim 1, wherein the casing includes the first cap and the second cap which are arranged on two outer ends of the casing respectively, the first cap has a first sheath and a second sheath fitted with the first cap, wherein an inner diameter of each of the first sheath and the second sheath is more than an inner diameter of the casing and is less than an outer diameter of each of the first cap and the second cap, and an outer diameter of each of the first cap and the second cap is more than an outer diameter of the casing so that the first sheath and the second sheath fit with the casing securely.

6. The safety structure as claimed in claim 1, wherein each shoulder has two flanges formed on two ends thereof respectively, and the fitting sleeve has a stepped portion arranged on a top of an inner wall thereof, hence when the first brake line is broken, the two flanges of each shoulder are stopped by the stepped portion so as to brake the vehicle firmly.
